(19) United States
(12) Patent Application Publication
(10) Pub. No.: US 2014/0304702 A1
(43) Pub. Date: Oct. 9, 2014

(54) Centralized System With Components and Features Hosting

(71) Applicant: CAREFUSION 303, INC., San Diego, CA (US)

(72) Inventors: Aron Weiler, San Diego, CA (US); Martin Orona, San Diego, CA (US)

(73) Assignee: CAREFUSION 303, INC., San Diego, CA (US)

(21) Appl. No.: 13/857,896

(22) Filed: Apr. 5, 2013

(51) Int. Cl. G06F 9/445; G06F 21/56

(52) U.S. Cl. CPC G06F 8/61; G06F 21/565; G06F 9/44521
USPC 717/176

(57) ABSTRACT

Adding of a component to an operating system process that is being executed on a node of a computing system comprising memory and at least one data processor is first initiated. The node is one of a plurality of nodes in a service oriented computing architecture. Thereafter, the component can be accessed from a local resource if available locally otherwise initiating a service to access the component exposed as a network service on a remote node of a centralized system. The component can then be deployed within the operating system process. Related apparatus, systems, techniques and articles are also described.

### TECHNICAL FIELD

The subject matter described herein relates to hosting of components and features by a centralized system and loading the components and features into operating system processes.

### BACKGROUND

Distributed computing systems are increasing in prevalence. Distributed computing system can adopt a service-oriented architecture (SOA) that provides a set of components that can be invoked and whose interface descriptions can be published and discovered. In this regard, a component is a software object that interacts with other components, encapsulating certain functionality or a set of functionalities. A component has a clearly defined interface and conforms to a prescribed behavior common to all components within an architecture. In an SOA, resources are made available to other participants in the network as independent services that are accessed in a standardized way. A service is a unit of work done by a service provider to achieve desired end results for a service consumer. Both provider and consumer are roles played by software agents on behalf of their owners.

### SUMMARY

In one aspect, adding of a component to an operating system process that is being executed on a node of a computing system comprising memory and at least one data processor is initiated. The node being one of a plurality of nodes in a service oriented computing architecture. Thereafter, the component can be accessed from a local resource if available locally otherwise initiating a service to access the component exposed as a network service on a remote node of a centralized system. The component can then be deployed within the operating system process.

In order to determine whether the component is available locally, a pre-defined directory on the node can be accessed to determine whether the component is available and already installed. The directory can include at least one file encapsulating the component. The at least one file can be a dynamic-link library file. Deploying the component can include loading the component from the dynamic-link library file into memory at the node. The contents of the file can be examined prior to deployment of the component within the operating system process to minimize a likelihood of the file comprising malicious content. Examining contents of the at least one file can include comparing a file type of the at least one file, comparing a provenance of the at least one file, and compare a naming pattern used by the at least one file against known malicious file attributes.

A registry can be provided by the centralized system can be polled to determine if the component at the node of the centralized system can be hosted within the operating system process. The polling can be periodic and/or it can occur upon the initiation of the deployment of the component. The centralized system can call a factory to instantiate at least one object associated with the component. Thereafter, the instantiated at least one object can be registered in the registry.

Computer program products are also described that comprise non-transitory computer readable media storing instructions, which when executed one or more data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, processing resources can be minimized and response times increased by using local resources (e.g., components, etc.) when available as opposed to initiating one or more service calls to remote nodes to access resources.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating a computing landscape within a healthcare environment;

FIGS. 2A-C are system diagram illustrating medical devices interacting with one or more centralized systems; and

FIG. 3 is a process flow diagram illustrating deployment of components within an executing operating system process.

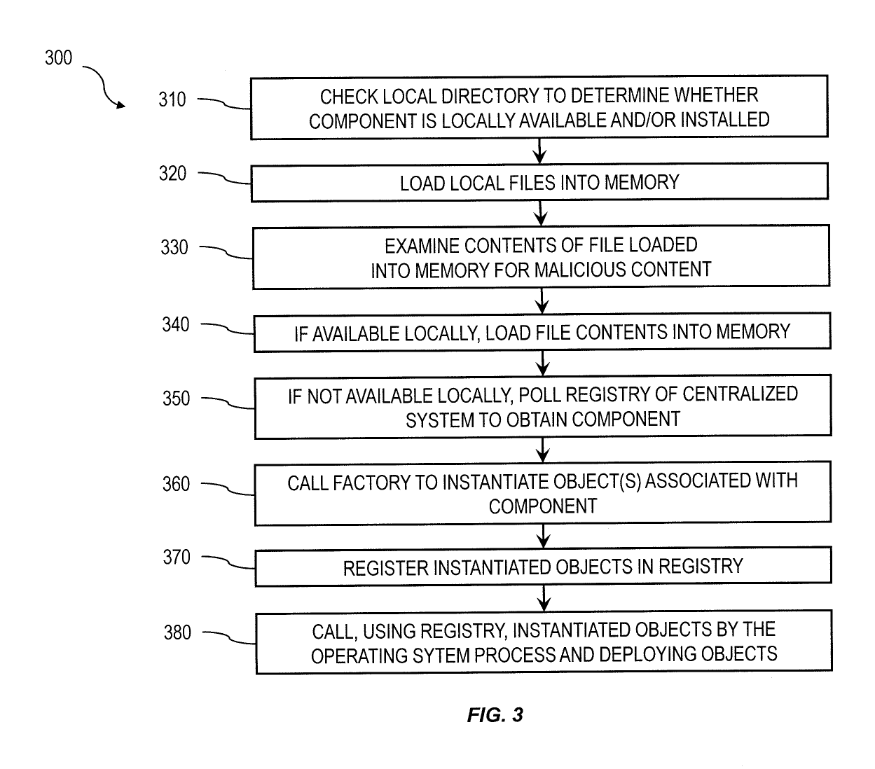

### DETAILED DESCRIPTION

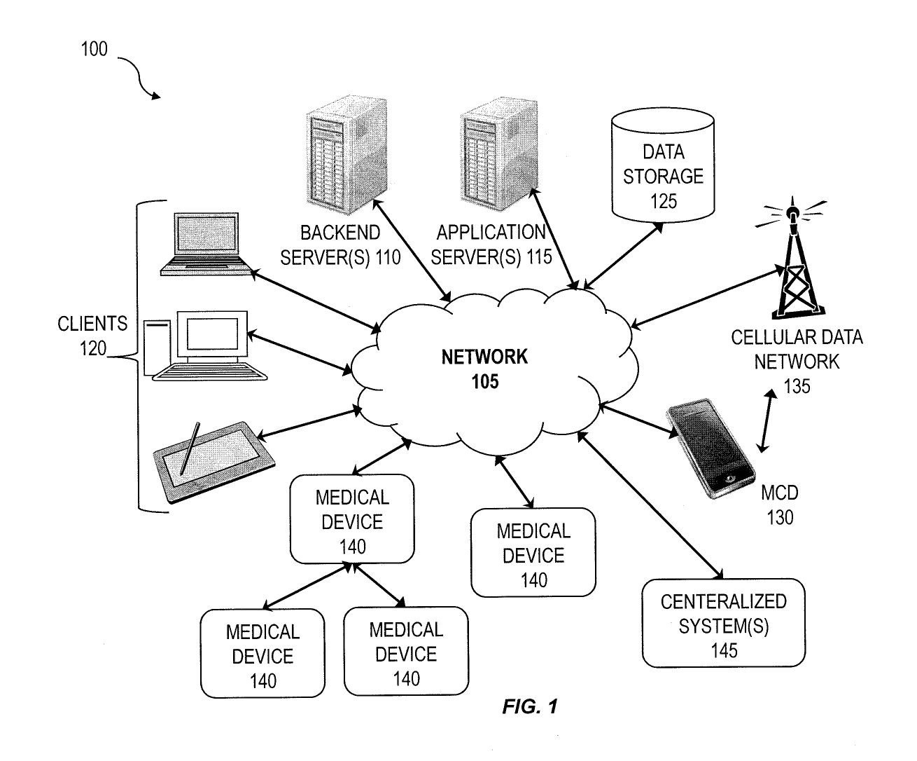

FIG. 1 is a system diagram illustrating a computing landscape 100 within a healthcare environment such as a hospital. Various devices and systems, both local to the healthcare environment and remote from the healthcare environment, can interact via at least one computing network 105. This computing network 105 can provide any form or medium of digital communication connectivity (e.g., wired connection, optical connection, wireless connection, and so forth) amongst the various devices and systems. Examples of communication networks include a local area network (“LAN”), a wide area network (“WAN”), and the Internet. In some cases, one or more of the various devices and systems can interact directly via peer-to-peer coupling (for example, via a hardwired connection or via a wireless protocol such as Bluetooth or WiFi). In addition, in some variations, one or more of the devices and systems communicate via a cellular data network.

In particular, aspects of the computing landscape 100 can be implemented in a computing system that includes a back-end component (e.g., as a data server 110), or that includes a middleware component (e.g., an application server 115), or that includes a front-end component (e.g., a client computer 120 having a graphical user interface or a Web browser through which a user may interact with an implementation of the subject matter described herein), or any combination of such back-end, middleware, or front-end components. A client 120 and server 110, 115 are generally remote from each other and typically interact through the communications network 105. The relationship of the clients 120 and servers 110, 115 arises by virtue of computer programs running on the respective computers and may have a client-server relationship to each other. Clients 120 can be any of a variety of computing platforms that include local applications for providing various functionality within the healthcare environment. Example clients 120 include, but are not limited to, desktop computers, laptop computers, tablets, and other computing devices that may have touch-screen interfaces. The local applications can be self-contained in that they do not require network connectivity and/or they can interact with one or more of the servers 110, 115 (e.g., a web browser).

A variety of applications can be executed on the various devices and systems within the computing landscape such as electronic health record applications, medical device monitoring, operation, and maintenance applications, scheduling applications, billing applications, and the like.

The network 105 can be coupled to one or more data storage systems 125. The data storage systems 125 can include databases providing physical data storage within the healthcare environment or within a dedicated facility. In addition, or in the alternative, the data storage systems 125 can include cloud-based systems providing remote storage of data in, for example, a multi-tenant computing environment. The data storage systems 125 can also comprise non-transitory computer readable media.

Mobile communications devices (MCDs) 130 can also form part of the computing landscape 100. The MCDs 130 can communicate directly via the network 105 and/or they can communicate with the network 105 via an intermediate network such as a cellular data network or other wired or wireless network. Various types of communication protocols can be used by the MCDs 130 including, for example, messaging protocols such as SMS and MMS.

Various types of medical devices 140 can be used as part of the computing landscape 100. These medical devices 140 can comprise, unless otherwise specified, any type of device or system with a communications interface that characterizes one or more physiological measurements of a patient and/or that characterizes treatment of a patient. In some cases, the medical devices 140 communicate via peer to peer wired or wireless communications with another medical device 140 (as opposed to communicating with the network 105). For example, the medical device 140 can comprise a bedside vital signs monitor that is connected to other medical devices 140, namely a wireless pulse oximeter and to a wired blood pressure monitor. One or more operational parameters of the medical devices 140 can be locally controlled by a clinician, controlled via a clinician via the network 105, and/or they can be controlled by one or more of a server 115, client 120, data storage systems 125, MCD 130, and/or another medical device 140.

The computing landscape 100 can provide various types of functionality as may be required within a healthcare environment such as a hospital. For example, a pharmacy can initiate a prescription via one of the client computers 120. This prescription can be stored in the data storage systems 125 and/or pushed out to other clients 120, an MCD 130, and/or one or more of the medical devices 140. In addition, the medical devices 140 can provide data characterizing one or more physiological measurements of a patient and/or treatment of a patient (e.g., medical device 140 can be an infusion management system, etc.). The data generated by the medical devices 140 can be communicated to other medical devices 140, the servers 110, 115, the clients 120, the MCDs 130, and/or stored in the data storage systems 125.

In some implementations consistent with FIG. 1, the computing landscape 100 includes at least one centralized system 145, medical devices 140, network 105, and cellular network 135. The at least one centralized system 145 comprises and/or utilizes one or more of clients 120, backend server(s) 110, application server(s) 115, data storage systems 125, and MCD 130. Computing devices 110, 115, 120, 125, and 130 may connect to the network 105 through any wired or wireless access network including cellular data network 135 or other network. Some medical devices can connect directly to network 105.

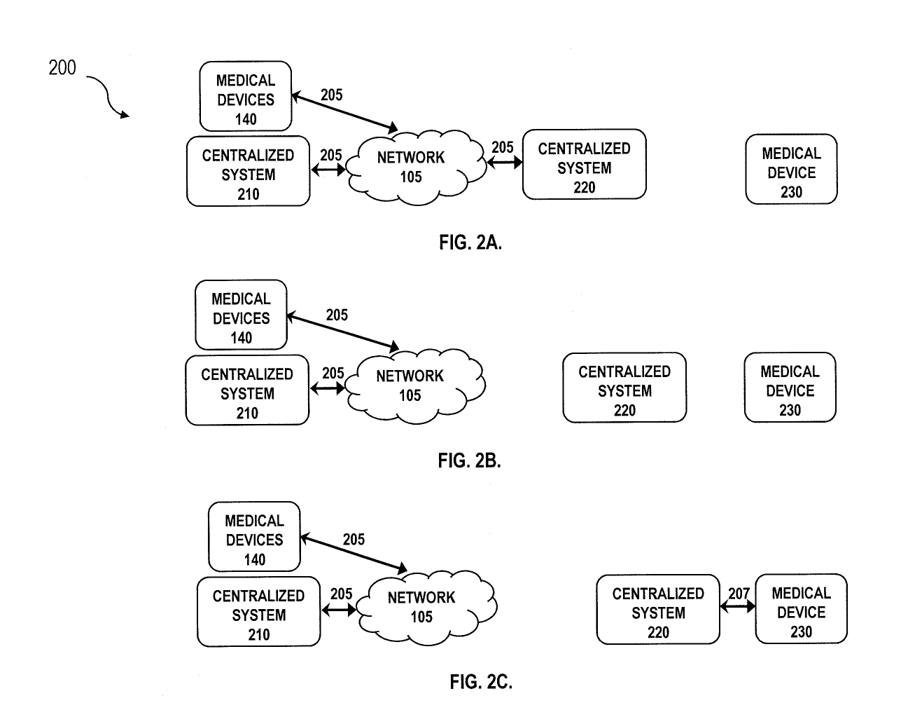

FIG. 2A depicts an example of a logical instance 200 of a centralized system (CS) 145. The logical instance 200 of the CS 145 can include a complete CS 145 for a hospital, building, company, organization, or location. In some implementations such as the logical instance in FIG. 2A, the logical instance can include multiple physical instances 210, 220 of centralized systems connected through a network such as network 105. Application data and configuration data stored on centralized system 210 can also be stored on centralized system 220. A physical instance such as centralized system 220 may reside on a laptop or other portable computing device while another physical instance such as centralized system 210 may reside on a central computer system in a hospital, for example. A physical instance such as centralized system 210 may reside on a plurality of computing systems that make up a central computing facility at a hospital, for example.

In the example shown in FIG. 2A, the logical instance 200 includes two physical instances—centralized system 210 and centralized system 220. The centralized systems are connected together through network 105. Centralized system 210 can be also connected to one or more medical devices 140. In some systems, the centralized system such as centralized system 210 can be connected to a large number of medical devices (e.g., thousands of medical devices, etc.). Although not shown in FIGS. 2A-2C, one or more centralized systems such as centralized systems 210 and 220 can be connected to the internet.

Network 105 provides for communication through connections 205 between computing devices such as centralized systems 210, 220, and communication through connections 205 between medical devices 140 and centralized systems 210, 220. Centralized systems 210, 220 can also have a connection to the internet. A user at a user interface, can access the CS 145 through a network connection 205. Each connection 205 can be a wired or wireless connection, a serial connection, parallel connection or any other type of communication connection. Connections 205 can also include additional gateways or routers to provide access through the internet.

A centralized system such as centralized system 210 can connect to between one and thousands of medical devices. In the example of FIG. 2A, centralized system 210 connects to medical devices 140 and centralized system 220 through network 105. When multiple medical devices are connected to a centralized system 145 they can connect through a switch or router not shown in FIGS. 2A-2C. The connections 205 between medical devices 140 and the centralized system can be wired or wireless connections, or any combination of wired and wireless connections. The centralized system such as centralized system 210 can provide commands that are individually addressed to one of the connected medical devices, or commands can be broadcast to multiple medical devices. Status data, maintenance data, usage data, and other data can be received at the centralized system from any attached medical device. Each centralized system such as centralized system 210 can maintain a list of medical devices connected to it such as medical devices 140. The list of medical devices connected to the CS 200 is sometimes referred to as a registry.

A user interface (e.g., a graphical user interface, etc.) to access a centralized system can facilitate sending commands and receiving information from any device in the CS 200. Before sending commands or accessing information, authentication of the user at the user interface may be required by the CS 200. For example, a user at a user interface can access the CS through a connection to network 105 or through the internet. The user at the user interface can be required to provide authentication information at the user interface, at the centralized system 210, 220 or both. Upon authentication, the user can send commands to medical devices 140 connected to the CS and/or receive information form the medical devices 140 or centralized systems 210, 220. The authentication credentials of a user can limit the types of commands that a user is allowed to send, the types of information the user is allowed to receive, and/or or the medical devices that the user may access. For example, a particular user may be able to receive only maintenance information from the medical devices on the CS 200 and no other information, and may not be allowed to send commands to the medical devices. For example, these limitations or similar limitations can be imposed on maintenance personnel at a hospital. Other examples include the physician for a patient who may be authorized to adjust a dosage level at a medical device where maintenance personnel would not be authorized to adjust dosages. Other limitations or sets of limitations are also possible.

A service oriented architecture can be implemented as part of the computing landscape 100 with the various devices and systems coupled to the network 105 being nodes within such landscape 100 (and the centralized system 145 comprising one or more of such nodes). Some or all of the nodes can be coupled to a component management system that provides, for example, information about which resources (e.g., components, etc.) are available across the computing landscape 100. The component management system can be, for example, a software layer. In addition, while the computing landscape 100 forms part of a healthcare environment, it will be appreciated that the current subject matter can be implemented in varying types of service oriented computing environments.

In some cases, it can be desirable to add a component to an operating system process executing on a particular node. Generally, speaking the node can access components if locally available and if not, the centralized system 145 can expose the component as network services. The operating system process can, at 310, first check a known directory on the node to determine whether a desired component is available and already installed. For example, the directory can include dynamic-link library file that encapsulate or otherwise characterize the requested component. Thereafter, at 320, if one or more files are found locally, the corresponding files can be loaded into the memory (e.g., RAM, etc.) of the node.

At this stage, at 330, the operating system process can examine the contents of the file(s) loaded into memory prior to deployment (at 340). The contents of the file can be examined, for example, by comparing against known attributes of malicious files. For example, various precautions can be undertaken to avoid loading malware into the operating system process such as examining one or more of the file type, the provenance of the file, and the naming pattern used by the file.

If the component is not available on the local node, it can be determined, at 350, whether the component can be hosted inside the operating system process. This determination can be made by polling a registry provided by the centralized system 145 either upon initialization and/or periodically thereafter.

If the registry indicates that the component is available remotely then, at 360, a factory can be called in order to instantiate one or more objects associated with the component. Thereafter, at 370, the instantiated one or more objects can be registered in the registry and at, 380, the instantiated objects can be called by the operating system process and deployed.

The current subject matter can be used in connection with various architectures including the subject matter described in U.S. patent application Ser. No. 13/830,306 filed on Mar. 14, 2013, the contents of which are hereby fully incorporated by reference.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A computer-implemented method comprising:
initiating, within a service oriented computing architecture, adding of a component to an operating system process being executed on a node of a computing system comprising memory and at least one data processor;
accessing the component from a local resource if available locally otherwise initiating a service to access the component exposed as a network service on a remote node of a centralized system; and
deploying the component within the operating system process.

2. A method as in claim 1, further comprising: checking a pre-defined directory on the node to determine whether the component is available and already installed.

3. A method as in claim 2, wherein the directory comprises at least one file encapsulating the component.

4. A method as in claim 3, wherein the at least one file is a dynamic-link library file.

5. A method as in claim 4, wherein deploying the component comprises loading the component from the dynamic-link library file into memory at the node.

6. A method as in claim 5, further comprising: examining contents of the file prior to deployment of the component within the operating system process to minimize a likelihood of the file comprising malicious content.

7. A method as in claim 6, wherein the examining contents comprises: comparing a file type of the file, comparing a provenance of the file, and compare a naming pattern used by the file against known malicious file attributes.

8. A method as in claim 1, further comprising:
polling a registry provided by the centralized system to determine if the component at the node of the centralized system can be hosted within the operating system process.

9. A method as in claim 8, wherein the polling is periodic.

10. A method as in claim 8, wherein the polling occurs upon the initiation of the adding of the component.

11. A method as in claim 8, further comprising:
calling, by the centralized system, a factory to instantiate at least one object associated with the component; and
registering the instantiated at least one object in the registry.

12. A non-transitory computer program product storing instructions, which when executed by at least one data processor of at least one computing system, result in operations comprising:
initiating, within a service oriented computing architecture, adding of a component to an operating system process being executed on a node of a computing system comprising memory and at least one data processor;
accessing the component from a local resource if available locally otherwise initiating a service to access the component exposed as a network service on a remote node of a centralized system; and
deploying the component within the operating system process.

13. A computer program product as in claim 12, wherein the operations further comprise: checking a pre-defined directory on the node to determine whether the component is available and already installed.

14. A computer program product as in claim 13, wherein the directory comprises at least one file encapsulating the component.

15. A computer program product as in claim 14, wherein the at least one file is a dynamic-link library file.

16. A computer program product as in claim 15, wherein deploying the component comprises loading the component from the dynamic-link library file into memory at the node.

17. A computer program product as in claim 16, wherein the operations further comprise: examining contents of the file prior to deployment of the component within the operating system process to minimize a likelihood of the file comprising malicious content.

18. A computer program product as in claim 17, wherein the examining contents comprises: comparing a file type of the file, comparing a provenance of the file, and compare a naming pattern used by the file against known malicious file attributes.

19. A computer program product as in claim 12, wherein the operations further comprise:
polling a registry provided by the centralized system to determine if the component at the node of the centralized system can be hosted within the operating system process;
wherein the polling is one or more of periodic and upon the initiation of the adding of the component.

20. A system comprising:
at least one data processor; and
memory storing instructions which, when executed by at least one data processor, result in operations comprising:
initiating, within a service oriented computing architecture, adding of a component to an operating system process being executed on a node of a computing system comprising memory and at least one data processor;
accessing the component from a local resource if available locally otherwise initiating a service to access the component exposed as a network service on a remote node of a centralized system; and
deploying the component within the operating system process.
